(19) United States
(12) Patent Application Publication
(10) Pub. No.: US 2009/0073186 A1
(43) Pub. Date: Mar. 19, 2009

(54) Automated generation of images

(76) Inventors: Roberto Caniglia, Montreal (CA); Robert Ste-Marie, St-Lazare (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/898,962

(22) Filed: Sep. 18, 2007

(51) Int. Cl. G09G 5/00

(52) U.S. Cl. 345/619

(57) ABSTRACT

There is described herein a method for generating an image, the method comprising: receiving at least one data file comprising at least one subject image and options information related to desired parameters for a rendered image, the options information including at least a selection for a template that defines a composition and layout for the rendered image and a selection for a background onto which the subject image is to be superimposed; retrieving the template from a database in accordance with the selection; generating the rendered image dynamically by replacing fields in the template with the at least one subject image and with elements corresponding to the options information; and outputting a signal embodying the rendered image.

### CROSS-REFERENCE TO RELATED APPLICATIONS

This is the first application filed for the present invention.

### TECHNICAL FIELD

The present invention relates to the field of photographic image reproduction, and more specifically, to a method and system used to process subject images in an automated fashion, in batches or individually.

### BACKGROUND

School pictures is one example of an instance when a photographer will shoot a plurality of subjects on location with the intention of selling images in printed or electronic format. In order to maximize business, photographers now offer a multitude of options for the final products, such as backgrounds, decorative borders, effects, customized text, etc.

Having a multitude of options increases the time and costs associated with producing each image. In addition, errors may more frequently occur when the options chosen are varied from one subject to another. Therefore, there is a need for a means that will allow a user to handle the multitude of choices offered while maximizing profits and efficiency.

### SUMMARY

In accordance with a first broad aspect of the present invention, there is provided an image generating system comprising: a processor in a computer system; a database accessible by the processor; and an application coupled to the processor, the application configured for: receiving at least one data file comprising at least one subject image and options information related to desired parameters for a rendered image, the options information including at least a selection for a template that defines a composition and layout for the rendered image and a selection for a background onto which the subject image is to be superimposed; retrieving the template from the database in accordance with the selection; and generating the rendered image dynamically by replacing fields in the template with the at least one subject image and with elements corresponding to the options information.

In accordance with a second broad aspect of the present invention, there is provided a method for generating an image, the method comprising: receiving at least one data file comprising at least one subject image and options information related to desired parameters for a rendered image, the options information including at least a selection for a template that defines a composition and layout for the rendered image and a selection for a background onto which the subject image is to be superimposed; retrieving the template from a database in accordance with the selection; generating the rendered image dynamically by replacing fields in the template with the at least one subject image and with elements corresponding to the options information; and outputting a signal embodying the rendered image.

In accordance with a third broad aspect of the present invention, there is provided an image generating system comprising: a database storing a plurality of data files each comprising at least one subject image and options information related to desired parameters for the rendered image, the options information including at least a selection for a background onto which the subject image is to be superimposed; and a rendering module adapted to retrieve the data files and automatically generate a rendered image for each of the data files by superimposing the at least one subject image over the background and providing elements corresponding to the options information.

In accordance with a fourth broad aspect of the present invention, there is provided a method for generating images, the method comprises: storing a plurality of data files each comprising at least one subject image and options information related to desired parameters for the rendered image, the options information including at least a selection for a background onto which the subject image is to be superimposed; retrieving the data files; and automatically generating a rendered image for each of the data files by superimposing the at least one subject image over the background and providing elements corresponding to the options information.

In this specification, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

For the purpose of the present description, the term “processor” is to be understood as a device that can perform operations on data. Examples are a central processing unit (CPU) and a front-end processor. For instance, a CPU directs data and instructions to and from other devices in the computer system, like the computer's memory and input devices. It also interprets programs. The term “database” is to be understood as a collection of data stored on a computer storage medium in a common pool for access on an as-needed basis. It can be a simple text file or a spread sheet, or have a more complex structure arranged from simplicity of searching and retrieving items. A “data file” is to be understood as a collection of data grouped together. In one embodiment, a data file relates to a single subject/person and can be represented by one line in a spreadsheet, text file, or database. A plurality of data files would then refer to multiple lines in the same spreadsheet, text file, or database.

### BRIEF DESCRIPTION OF THE DRAWINGS

Further features and advantages of the present invention will become apparent from the following detailed description, taken in combination with the appended drawings, in which:

FIG. 1 is an embodiment of a photographic test print produced with the method and system of the present invention;

FIG. 2 is an embodiment of a print package produced with the method and system of the present invention;

FIG. 3 is a block diagram illustrating an embodiment of the system of the present invention using templates;

FIG. 4 is a block diagram illustrating an embodiment of the system of the present invention without the use of templates;

FIG. 5 is a screen shot of a text file comprising multiple data files as per an embodiment of the present invention; and

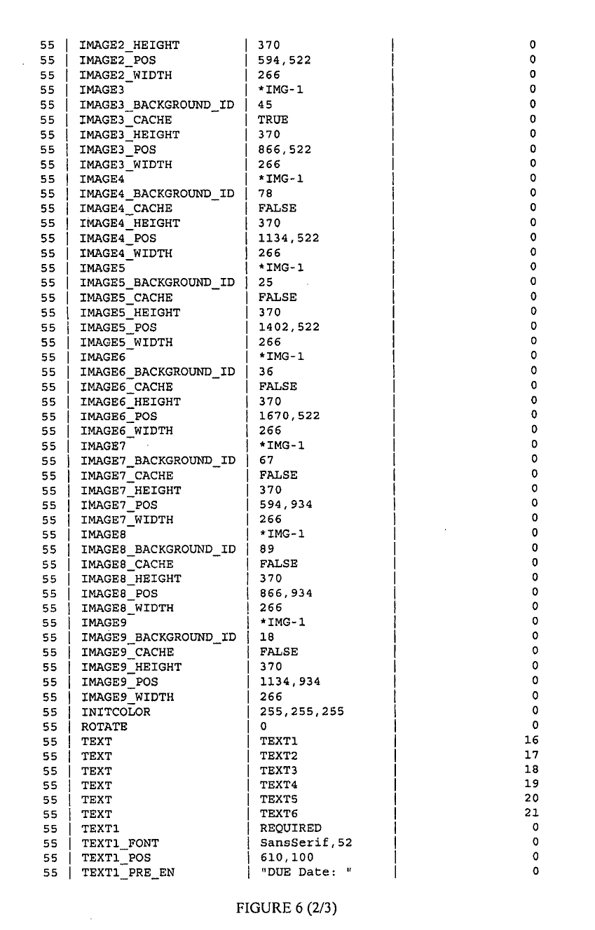

FIG. 6 is a sample template in an SQL database and includes sheets 1/3-3/3.

It will be noted that throughout the appended drawings, like features are identified by like reference numerals.

### DETAILED DESCRIPTION

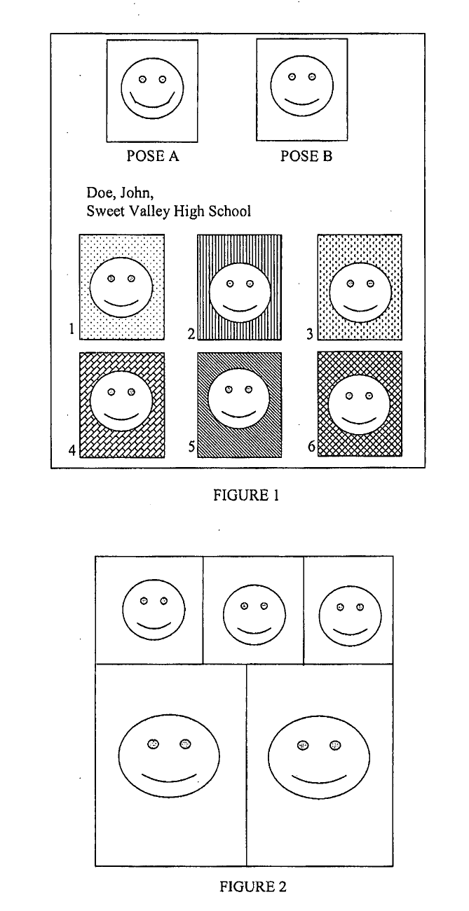

A rendered image may be provided on one or more sheets of photographic paper. In one embodiment, a rendered image corresponds to a photographic test print. A test print may have a single pose with multiple backgrounds, multiple poses with multiple backgrounds, or multiple poses with a single background. An embodiment of a photographic test print is illustrated in FIG. 1. In this embodiment, two poses (Pose A and Pose B) are shown at the top of the test print. One of these poses (Pose B) is then reproduced six times in a 2×3 matrix superimposed onto different backgrounds. Text can also provided on the test print to identify the subject and the school of the subject. Additional information may also be provided on the test print, such as a barcode matched to a student (possibly corresponding to a student card) and additional information related to the student, the location of the photo shoot, or the test print itself.

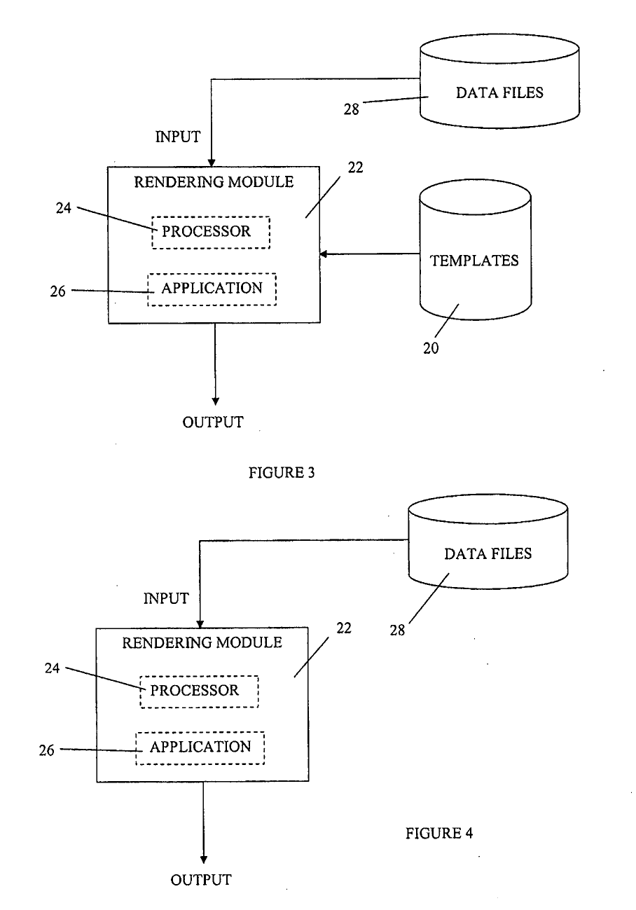

FIG. 2 illustrates another embodiment for a rendered image. In this case, the rendered image is a single sheet such as those found in a print package commonly received by students for their school pictures. In FIG. 2, a single pose is provided twice in a first format size (such as 5×7) and three times in a second format size (such as 2.5×3.5). In yet another embodiment, the rendered image may correspond to multiple sheets such as that illustrated in FIG. 2, with different combinations of format sizes.

It can be appreciated that the rendered image may also be stored on a portable computer-readable storage medium, such as a CD, a USB key, a memory card, or other. Alternatively, the rendered image may be provided online via the internet or any other network available to multiple users (such as an intranet).

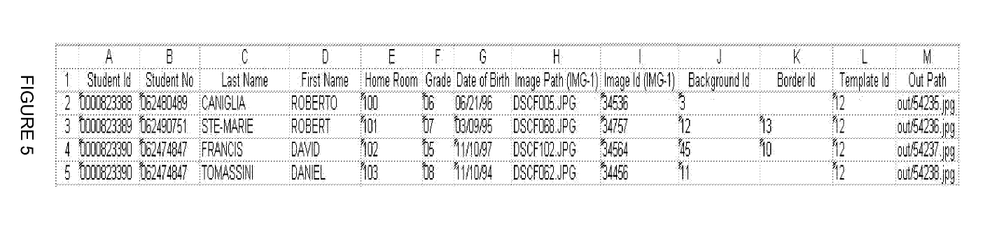

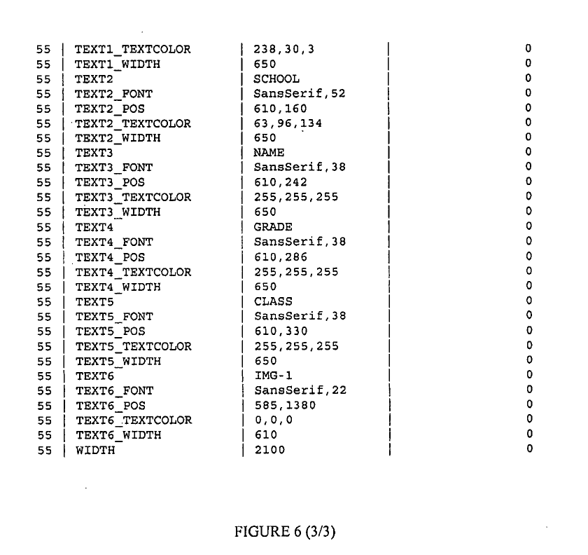

FIG. 3 illustrates an embodiment of the system used to generate the rendered image. A database 20 holds a plurality of templates used to render the image. Each template is an electronic file that defines the composition and layout for each element of a dynamically generated image. A sample template can be found in FIG. 6 (1/3-3/3).

Each template contains references to static parameters that are predefined for a given template, and dynamic parameters that are defined at runtime. Examples of static parameters are fixed artwork in the layout, the position of one or more subject images on the layout, and the number of subject images on the layout. Examples of dynamic parameters are backgrounds for subject images, effects, text, borders, and others. The dynamic parameters are fields that are replaced dynamically at runtime by user-selected content. Each different type of rendered image (i.e. test print, print package, single sheet, etc) will correspond to a different group of templates and each template in each group will have multiple combinations for its layout and composition.

A rendering module 22, accesses the template database 20 and retrieves the appropriate template. The selection for the template is received with a data file via the input. The data file contains all of the information used to render the image. An example of a plurality of data files in a text file is illustrated in FIG. 6. At least one subject image and options information related to desired parameters for the rendered image are received. The options information includes a selection for a template for the rendered image. It may also include a selection for one or more backgrounds to be applied with the subject image, borders, effects, text, etc. Each different element in the options information corresponds to a field in the template that may be replaced. If the element is not present in the data file, default parameters are entered into the given fields when the image is generated at runtime.

An application 26 is coupled to a microprocessor 24 and is configured for receiving the data file, retrieving the appropriate template from the database, and generating the rendered image dynamically by replacing the fields in the template with the appropriate content.

The application 26 is also configured to process multiple files automatically. The files may be received by having the rendering module 22 access a database 28 having one or several electronic files that contain the data files for the images to be rendered. The files are accessed sequentially by the rendering module 22. Alternatively, the data files may be fed into the rendering module 22 without having been stored in a database. The output of the rendering module 22 is a signal embodying the rendered image. The signal may be used to print onto photographic paper as illustrated in FIGS. 1 and 2, may be saved onto a storage medium such as a CD, or may be used to make the rendered images available on the internet.

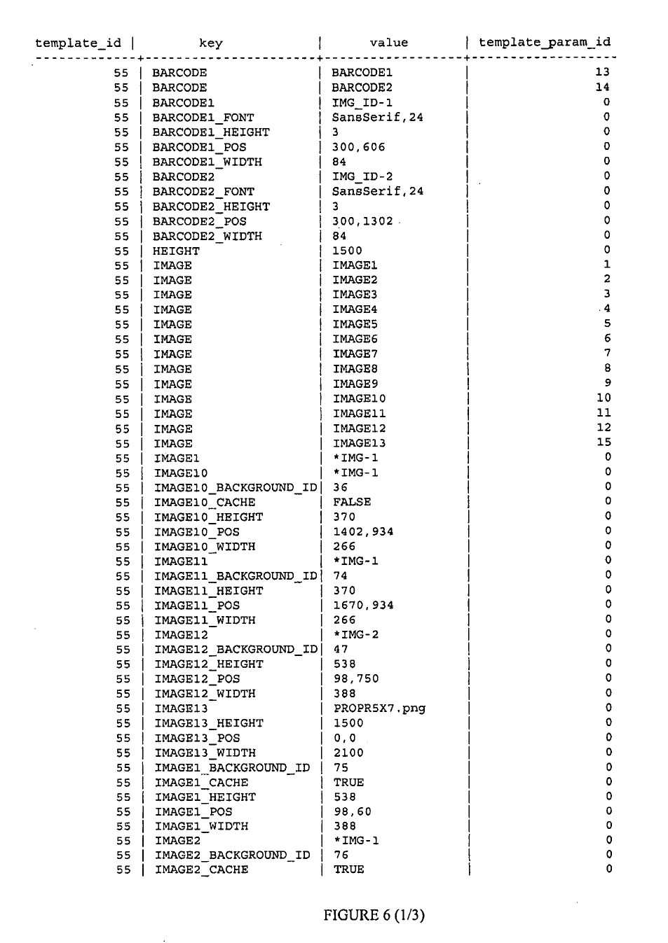

In accordance with an embodiment illustrated in FIG. 4, the system may generate the rendered images without the use of templates. In this case, the data files are stored in a database 28 and retrieved by the rendering module 22. Each data file contains at least one subject image and a selection of at least one background. The subject image is superimposed onto the selected background. A single data file may have multiple subject images to be associated with multiple backgrounds. Alternatively, a single data file may have one subject image associated with multiple backgrounds, as illustrated in FIG. 1. Also alternatively, a single data file may have multiple subject images associated with a single background, or a single subject image associated with a single background. Other parameters may also be provided as options information, as described above.

The method for generating a rendered image may be used by photographers who shoot a plurality of subjects on location with the intention of selling images in printed or electronic format. An example is a school photographer. A photographer may use data files for the students being photographed. A new entry is created for each student and student information is stored electronically. The images for a given student will be matched to a student entry.

The photographer may then generate a set or batch of photographs by providing one or more electronic entries containing one or more data files, each data file referencing at least one subject image and a selection for a template. Multiple data files can be grouped together for a single template or each data file can be treated separately. Data files may be grouped according to common option selections, such as template, subject information, background, etc.

Below is an example of code to create data files to be processed automatically by the image processor. Each data entry is composed of student info, image and template ID:

```
DataItem [ ] dia = schoolData.getStudents( ).getFilteredArray(true, false, df, intSort, true, false,
false);//apply sort and filters
for (int n=0; n<dia.length; ++n) {
    image = schoolData.getImage(dia[n].getImageId( ));
    strImagePath = schoolData.getPath( ) + “corrected” + File.separator + image.getPath( );
    ++intIndex;
    hParam.put(“IMG-”+Integer.toString(intIndex), strImagePath);
    hParam.put(“IMG_ID-”+Integer.toString(intIndex), Integer.toString(image.getId( )));
    strImageKey = “IMG-”+Integer.toString(intIndex);
    hParam.put(strImageKey + “_crop_params”, (new CropParams(image, user)).getHash( ));
    student = schoolData.getStudent(di.getStudentId( ));
    ++intOutCount;
    hParam.put(“action”, “template”);
    hParam.put(“orderId”, strOrderId);
    hParam.put(“template_id”, template.getId( ));
    hParam.put(“user”, users.getUser(schoolOwner.getId( )).getUsername( ));
    hParam.put(“lang”, APP.SLID[schoolData.getLid( )]);
    hParam.put(“CLASS”, student.getClassNo( ));
    hParam.put(“GRADE”, student.getGrade( ));
    hParam.put(“LAST_NAME”, student.getLastName( ));
    hParam.put(“FIRST_NAME”, student.getFirstName( ));
    hParam.put(“NAME”, student.getName( ));
    hParam.put(“DOB”, student.getDOB( ).trim( ));
    hParam.put(“STUDENT_NO”, student.getStudentNo( ));
    hParam.put(“SCHOOL”, schoolData.getName( ));
    hParam.put(“REQUIRED”, sdfp.format(new java.util.Date(sd.getRequiredTs( ))));
    strPathOut = schoolData.getPath( ) + “TEMP” + File.separator + strJobFolder +
File.separator + student.getId( ) + “.” + (String)hParam.get(“IMG_ID-1”) + “.jpg”;
    hParam.put(“out”, strPathOut);
    eKeys = hTemplatOptions.keys( );
    while(eKeys.hasMoreElements( )) {
        strKey = (String)eKeys.nextElement( );
        hParam.put(strKey, hTemplateOptions.get(strKey));
    }
    imageProcessor.process(hParam);
}
```

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiments. For example, the means for retrieving the template from the database in accordance with a template selection are software means implemented with an algorithm in any given programming language.

An example of code used for retrieving a template info from an SQL database can be found below:

```
ds = (DataSource) (new InitialContext( )).lookup(strPool);
dbCon = ds.getConnection( );
String strKey = “”;
String strValue = “”;
ps = dbCon.prepareStatement(“SELECT * FROM TEMPLATE_PARAM
WHERE TEMPLATE_ID=? ORDER BY TEMPLATE_PARAM_ID”);
ps.setString (1, strTemplateId);
rs = ps.executeQuery( );
Hashtable hash;
while (rs.next( )) {
    strKey = rs.getString(“key”);
    if ((strKey.equals(“IMAGE”)) || (strKey.equals(“TEXT”))
|| (strKey.equals(“DTEXT”)) || (strKey.equals(“BARCODE”)))
        vTemplateParam.add(rs.getString(“value”));
    else
        hTemplateParam.put(strKey, rs.getString(“value”));
}
```

The means for generating the rendered image dynamically by replacing fields in the template with the subject image and with elements corresponding to the options information are also software means implemented with an algorithm in any given programming language.

It should be noted that the present invention can be carried out as a method, can be embodied in a system, a computer readable medium or an electrical or electromagnetic signal. The embodiments of the invention described above are intended to be exemplary only. The scope of the invention is therefore intended to be limited solely by the scope of the appended claims.

I claim:

1. An image generating system comprising:
a processor in a computer system;
a database accessible by the processor; and
an application coupled to the processor, the application configured for:
receiving at least one data file comprising at least one subject image and options information related to desired parameters for a rendered image, the options information including at least a selection for a template that defines a composition and layout for said rendered image and a selection for a background onto which said subject image is to be superimposed;
retrieving said template from said database in accordance with said selection; and
generating said rendered image automatically by replacing fields in said template with said at least one subject image and with elements corresponding to said options information.

2. An image generating system as claimed in claim 1, wherein said application is configured for processing a plurality of data files in an automated fashion.

3. An image generating system as claimed in claim 1, wherein said options information comprises subject information.

4. An image generating system as claimed in claim 2, wherein said application is configured to receive a group of said plurality of data files.

5. An image generating system as claimed in claim 4, wherein all of said data files in said group have at least one of template, background, and subject information in common.

6. An image generating system as claimed in claim 1, wherein said template defines a layout for a photographic test print having multiple subject images thereon.

7. An image generating system as claimed in claim 6, wherein said template has a distinct field for each background of each of said subject images.

8. An image generating system as claimed in claim 1, wherein said template defines a layout for a print package for a single pose represented in multiple sizes.

9. An image generating system as claimed in claim 1, wherein said computer system is coupled to a network accessible by multiple users.

10. An image generating system as claimed in claim 1, wherein said template defines a layout for a same subject image superimposed on multiple backgrounds.

11. A method for generating an image, the method comprising:
receiving at least one data file comprising at least one subject image and options information related to desired parameters for a rendered image, the options information including at least a selection for a template that defines a composition and layout for said rendered image and a selection for a background onto which said subject image is to be superimposed;
retrieving said template from a database in accordance with said selection;
generating said rendered image automatically by replacing fields in said template with said at least one subject image and with elements corresponding to said options information; and
outputting a signal embodying said rendered image.

12. A method as claimed in claim 11, wherein said receiving at least one data file comprises receiving a plurality of data files, and said steps of retrieving and generating are performed for each one of said data files in an automated fashion.

13. A method as claimed in claim 11, wherein said generating comprises generating a photographic test print having multiple subject images thereon.

14. A method as claimed in claim 13, wherein each of said subject images is superimposed onto a different background.

15. A method as claimed in claim 11, wherein said generating comprises generating a print package having a single subject image represented in multiple sizes.

16. A method as claimed in claim 11, wherein said generating comprises generating a rendered image having a single subject image represented on multiple backgrounds.

17. A method as claimed in claim 11, further comprising storing said signal on a portable computer-readable storage medium.

18. A method as claimed in claim 11, further comprising providing said rendered image on a multi-user network.

19. An image generating system comprising:
a database storing a plurality of data files each comprising at least one subject image and options information related to desired parameters for said rendered image, the options information including at least a selection for a background onto which said subject image is to be superimposed; and
a rendering module adapted to retrieve said data files and automatically generate a rendered image for each of said data files by superimposing said at least one subject image over said background and providing elements corresponding to said options information.

20. An image generating system as claimed in claim 19, wherein said options information comprises multiple backgrounds associated with different subject images, and said rendering module is adapted to match each subject image with a corresponding background.

21. An image generating system as claimed in claim 19, wherein said options information comprises multiple backgrounds associated with a same subject image, and said rendering module is adapted to generate a rendered image with said subject image on each one of said multiple backgrounds.

22. An image generating system as claimed in claim 19, wherein said selection for a background is a same background for all of said data files.

23. A method for generating images, the method comprises:
storing a plurality of data files each comprising at least one subject image and options information related to desired parameters for said rendered image, the options information including at least a selection for a background onto which said subject image is to be superimposed;
retrieving said data files; and
automatically generating a rendered image for each of said data files by superimposing said at least one subject image over said background and providing elements corresponding to said options information.

24. A method as claimed in claim 23, wherein said options information comprises multiple backgrounds associated with different subject images, and said automatically generating comprises matching each subject image with a corresponding background.

25. A method as claimed in claim 23, wherein said options information comprises multiple backgrounds associated with a same subject image, and said automatically generating comprises generating a rendered image with said subject image on each one of said multiple backgrounds.
